(19) United States
(12) Patent Application Publication
(10) Pub. No.: US 2020/0227189 A1
(43) Pub. Date: Jul. 16, 2020

(54) ELECTROMAGNET AND A METHOD FOR THE PRODUCTION THEREOF

(71) Applicant: THOMAS MAGNETE GMBH, Herdorf (DE)

(72) Inventors: Juergen SCHONLAU, Daaden (DE); Marc LEINWEBER, Neunkirchen (DE); Michael ERMERT, Kirburg (DE); Christian HÄBERLE, Siegen (DE); Christian MOHNCKE, Derschen (DE)

(73) Assignee: THOMAS MAGNETE GMBH, Herdorf (DE)

(21) Appl. No.: 15/754,907

(22) PCT Filed: Aug. 2, 2016
(86) PCT No.: PCT/EP2016/001332

§ 371 Date: Feb. 23, 2018

(30) Foreign Application Priority Data
Aug. 25, 2015 (DE) 10 2015 011 238.4

(51) Int. Cl. H01F 7/129; F16K 31/06; H01F 7/16

(52) U.S. Cl. CPC H01F 7/129; H01F 2007/085; H01F 7/1607; F16K 31/0675

(57) ABSTRACT

The electromagnet, at least comprising a magnet coil wound onto a coil core, a housing, a pole core, an armature, an armature rod and a yoke, should have a very low hysteresis of the force with a variable stroke at low manufacturing costs. The coil core is manufactured by jointly overmolding or overcasting the yoke, the pole core and the core flange with a plastic mass, wherein the axial intermediate space between the yoke and the pole core (4) is also filled with the plastic mass. Electromagnets of the described type are used for actuating fluid valves or couplings, preferentially in motor vehicles or in mobile working machines.

### CROSS REFERENCE TO RELATED APPLICATIONS

This application is a 371 National Stage of International Application No. PCT/EP2016/001332, filed on Aug. 2, 2016, which claims the benefit of and priority to German Patent Application 10 2015 011 238.4 filed on Aug. 25, 2015. The entire disclosures of the above applications are incorporated by reference herein.

### FIELD

The invention relates to an electromagnet.

### BACKGROUND

This section provides background information related to the present disclosure which is not necessarily prior art.

Electromagnets, which transform an electrical current into a mechanical force, are known, for example, from the publication DE 10 2012 022 254 B3.

Such electromagnets generally comprise a stator and an armature, the stator comprising a magnet coil for the creation of a magnetic flux and a flux-conducting element.

An important flux-conducting element is the pole core, which is adjacent to the armature and delimits a variable axial air gap between it and the armature.

The force of the magnet acts on the air gap.

In order to achieve a force proportionate to the current in a certain stroke range independent of the stroke, a pole core having an integrally formed cone is used.

Other essential flux-guiding elements are the core flange, the housing and the yoke, which guide the magnetic flux around the magnet coil and to the armature.

The yoke advantageously also holds the armature.

In older known designs of proportionally acting electromagnets, the yoke and the pole core, as well as a spacer ring, are soldered together and together form a pole tube.

In these designs, the spacer ring is manufactured from a metallic material having a very low magnetic conductivity, while the yoke and the pole core are manufactured from a material having a very high magnetic conductivity.

The low magnetic conductivity of the spacer ring is required in order to prevent a magnetic short circuit across the axial air gap.

The embodiment described above having a soldered pole tube achieves an outstanding linearity of the conversion between current and force as well as a low hysteresis of the force in the case of a variable stroke, but it has high manufacturing costs.

An alternative known embodiment has a pole tube made of austenitic iron that serves to support the armature. This design can be manufactured at low cost, but it has a significantly higher hysteresis of the force in the case of a variable stroke.

### SUMMARY

An electromagnet is to be described that has a very low hysteresis of the force while having a variable stroke with low manufacturing cost.

The low hysteresis of the force in the case of a variable stroke is achieved by geometric design of the yoke and the pole core in such a manner as is typical in the example with the rolled pole tube and by support of the armature in the yoke.

In any case, no metallic spacer ring is used between the yoke and the pole core. Instead of this, the intermediate space between the yoke and the pole core is filled with plastic.

Instead of connecting a magnet coil to its own coil core made of plastic via a pole tube, a coil core is used here that comprises the yoke, the pole core, a pole plate and the plastic mass.

The plastic mass also achieves the object of connecting the metallic parts of the coil core with each other.

The yoke has a flange that is integrally formed or is pressed on as a separate component.

In the molding or casting process, the intermediate space between the yoke and the pole core is filled with the plastic mass.

The coil core thus produced is wound around by the magnet coil and enclosed by a housing that also has the property of an iron counter plate.

The winding of the coil core deforms the inner diameter thereof, which therefore must be reworked mechanically by reaming after the winding, because this inner diameter serves to support the armature. Next, the armature rod is connected into the pole core and the armature is joined into the yoke.

Finally, the yoke is provided with an end plate provided with holes, either by welding the plate onto the yoke or by pressing the plate into the yoke.

Electromagnets of the described type are used for actuating fluid valves or couplings, preferentially in motor vehicles or in mobile working machines.

### BRIEF DESCRIPTION OF THE DRAWINGS

The drawings described herein are for illustrative purposes only of selected embodiments and not all possible implementations, and are not intended to limit the scope of the present disclosure.

FIG. 1 shows the electromagnet in detail.

Corresponding reference numerals indicate corresponding parts throughout the several views of the drawings.

### DETAILED DESCRIPTION OF THE PREFERRED EMBODIMENTS

Example embodiments will now be described more fully with reference to the accompanying drawings.

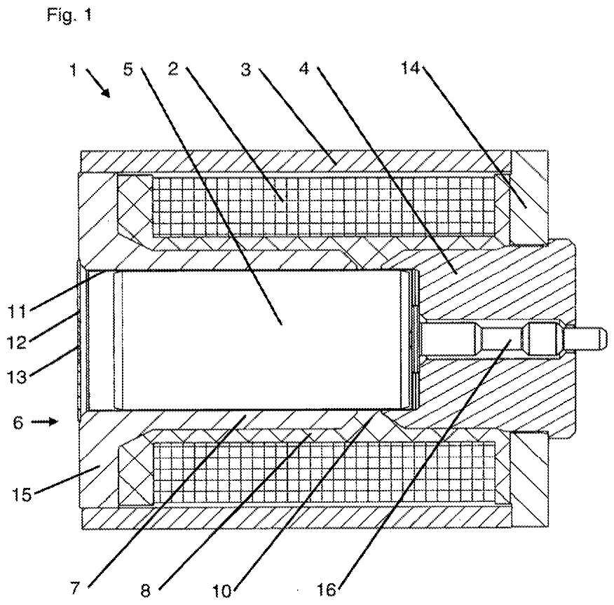

The electromagnet (1) according to FIG. 1 is made up of at least one magnet coil (2) wound around a coil core (6), a housing (3), a pole core (4), an armature (5) having an armature rod (16) and a yoke (7).

The coil core (6) includes the yoke (7), the pole core (4) and the core flange (14), the coil core (6) being manufactured by jointly overmolding or overcasting the yoke (7), the pole core (4) and the core flange (14) with a plastic mass (8), and the axial intermediate space (10) between the yoke (7) and the pole core (4) also being filled with the plastic mass.

The pole core (4) is surrounded by a core flange (14) that guides the magnetic flux from the housing (3) to the pole core (4). Alternatively, the pole core (4) and the core flange (14) are designed as one piece.

The yoke (7) including the armature (5) is equipped with a flange (15) that guides the magnetic flux from the housing (3) to the armature (5). Alternatively, the flange (15) and the yoke (7) are two parts that are joined by compression.

An end plate (12) is welded onto the yoke (7), which serves as a stop for the armature (5) and has one hole or a plurality of holes (13). As an alternative to welding, the end plate (12) is joined by compression into the yoke (7).

The housing (3) comprises the magnet coil (2) and the yoke (7).

At least the following steps are provided for production of the electromagnets:
overmolding or overcasting the yoke (7), the pole core (4) and the core flange (14) with a plastic mass (8) to produce the coil core (6);
winding the coil core (6) with the magnet coil (2);
joining the housing (3) around the yoke (7) and the magnetic coil (2);
reaming of the inner diameter (11) of the coil core (6);
joining the armature rod (16) and the armature (5) into the yoke (7); and
welding the end plate (12 to the yoke (7).

### LIST OF REFERENCE CHARACTERS

1. electromagnet
2. magnet coil
3. housing
4. pole core
5. armature
6. coil core
7. yoke
8. plastic mass
9. intermediate space
10. inner diameter
11. end plate
12. hole
13. core flange
14. flange
15. armature rod

1. An electromagnet comprising: a magnet coil wound onto a coil core, a housing, a pole core, an armature, an armature rod and a yoke, wherein
the coil core includes the yoke, the pole core and a core flange, the coil core being manufactured by jointly overmolding or overcasting the yoke, the pole core and the core flange with a plastic mass, and the axial intermediate space between the yoke and the pole core also being filled with the plastic mass.

2. The electromagnet according to claim 1, wherein the yoke comprising the armature is equipped with a flange that guides the magnetic flux from the housing to the armature.

3. The electromagnet according to claim 1, wherein an end plate is welded onto the yoke, which serves as a stop to the armature.

4. The electromagnet according to claim 1, wherein an end plate is pressed into the yoke that serves the armature as a stop.

5. The electromagnet according to claim 3, wherein the end plate has a hole or plurality of holes.

6. The electromagnet according to claim 1, wherein the core flange and the pole core are designed as one piece.

7. A method for the production of an electromagnet having a magnet coil wound onto a coil core, a housing, a pole core, an armature, an armature rod and a yoke, comprising:
overmolding or overcasting the yoke, the pole core and the core flange with a plastic mass to produce the coil core;
winding the coil core with the magnet coil;
joining the housing around the yoke and the magnetic coil;
reaming of an inner diameter of the coil core;
joining the armature rod and the armature into the yoke; and
welding the end plate onto the yoke or pressing the end plate into the yoke.
